(19) United States
(12) Patent Application Publication
(10) Pub. No.: US 2016/0314704 A1
(43) Pub. Date: Oct. 27, 2016

(54) INTERACTIVE PRODUCT ASSEMBLY AND REPAIR

(71) Applicant: SAP SE, Walldorf (DE)

(72) Inventor: Christina Bell, Hull, MA (US)

(21) Appl. No.: 14/693,605

(22) Filed: Apr. 22, 2015

(51) Int. Cl. G09B 19/00; G09B 9/00; G06Q 50/00; G09B 5/02

(52) U.S. Cl. CPC G09B 19/00; G09B 5/02; G09B 9/00; G06Q 50/01

(57) ABSTRACT

A system and a method for generating an interactive presentation involve outputting a virtual model of a physical object on a display. Data describing actions being applied to the virtual model is received. A performance metric is calculated based on comparisons between a predefined sequence of physical actions and the applied actions. The predefined sequence describes an assembly or repair process of the object. The performance metric is stored in a user profile for subsequent analysis.

### BACKGROUND INFORMATION

Product assembly and repair is often tedious and frustrating work. Inexperienced product users often have difficulty following printed instructions. Experienced users, who assemble the same or similar products frequently, can become considerably skilled technicians, yet lack an effective showcase for their work. The technician's reputation typically grows slowly, e.g., via word of mouth. At the same time, those seeking a good technician don't know where to look or how to assess a technician's skill level.

An improvement over printed instructions is available from SAP AG, in the form of a software application, known as BILT, which enables users to view an instructional video of an assembly process. However, user interactivity is limited.

### BRIEF DESCRIPTION OF THE DRAWINGS

FIG. 1 is a block diagram of a system for teaching product assembly and repair according to an example embodiment of the present invention.

FIG. 2 is a block diagram an object file for an interactive presentation according to an example embodiment of the present invention.

FIG. 3 is a block diagram a user profile according to an example embodiment of the present invention.

FIG. 4 shows a graphical user interface for locating interactive presentations according to an example embodiment of the present invention.

FIG. 5 shows a graphical user interface for presenting an interactive presentation according to an example embodiment of the present invention.

FIG. 6 shows a graphical user interface for accessing a job database according to an example embodiment of the present invention.

FIG. 7 shows a graphical user interface for accessing presentation related promotions according to an example embodiment of the present invention.

FIG. 8 shows another graphical user interface for accessing presentation related promotions according to an example embodiment of the present invention.

FIG. 9 shows a graphical user interface for submitting presentation related feedback according to an example embodiment of the present invention.

FIG. 10 shows a graphical user interface for accessing profiles of other presentation users according to an example embodiment of the present invention.

FIG. 11 shows a graphical user interface for sharing interactive assembly results with other users according to an example embodiment of the present invention.

FIG. 12 shows a graphical user interface for accessing assembly results according to an example embodiment of the present invention.

FIG. 13 is a flowchart of a method for creating an interactive presentation according to an example embodiment of the present invention.

FIG. 14 is a flowchart of a method for analyzing interactive presentation results according to an example embodiment of the present invention.

### DETAILED DESCRIPTION

The present invention relates to a system and methods for teaching product assembly and/or repair through interactive presentations. The present invention also relates to using interactive presentations to improve product manufacturing and/or assembly processes, and to promote products or services such as product assembly services performed by users of the presentations.

Example embodiments of a system and methods for teaching product assembly and/or repair through interactive presentations will be described in connection with various graphical user interfaces (GUIs). For simplicity, the GUIs and methods will be described mainly in reference to product assembly tasks. However, it will be understood that the example embodiments, including the GUIs and methods, are equally applicable to product repairs. In an example embodiment, an interactive presentation may include an instructional video showing each step required to complete an assembly or repair of a particular product. The video may be viewed in a conventional, static fashion. A user may interact with the video by, for example, pausing the video to examine a product part in closer detail, fast forwarding rewinding etc. Other forms of interaction may include the ability to test the user's assembly skills by challenging the user to assemble, in a virtual fashion, the product by repeating an assembly sequence shown in the video. Thus, the interactive presentation may include a virtual assembly/repair game.

In an example embodiment, the presentation may involve a three-dimensional (3D) model of the product. The user may interact with the presentation by virtually manipulating the model, for example, rotating or moving individual parts, and zooming in or out of a current view. Thus, the model may be viewed from different perspectives, e.g. during video playback. Similar manipulation may occur when the user attempts to virtually assemble the product.

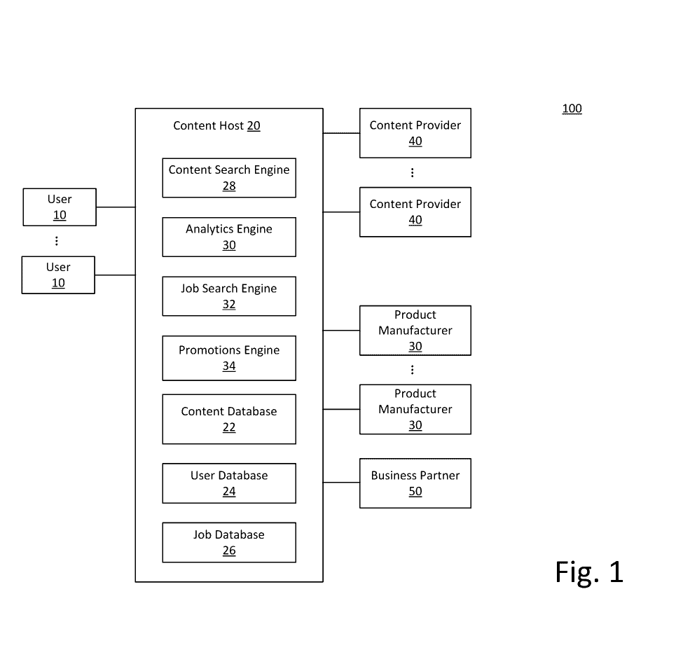

FIG. 1 is a block diagram of a system 100 for teaching product assembly and repair according to an example embodiment of the present invention. The system 100 includes a plurality of user devices 10 in electronic communication with a content host 20. A plurality of product manufacturers 30, content providers 40, and at least one business partner 50 (shown as single instance for simplicity) may also be in electronic communication with the host 20. Communication between each of the entities shown in FIG. 1 may involve wired and/or wireless transmissions over a network, e.g., occurring through the Internet or a cellular network. Various communication protocols may be used including, but not limited to, Hypertext Transfer Protocol (HTTP), Representational State Transfer (REST), File Transfer Protocol (FTP), and Simple Object Access protocol (SOAP).

Each user device 10 may comprise a computer such as a laptop, smartphone, tablet or other mobile computer. Non-mobile devices such as personal computers and workstations are also possible. The user device 10 may communicate with the host 20 through a local software application, e.g., a mobile app. The local application may communicate with the host 20 through an application program interface (API) to a corresponding application running on the host 20. The user device 10 may include a touchscreen display by which the example GUIs described herein are viewed and interacted with. For example, the user may apply finger gestures to rotate the model displayed on the touchscreen. Alternatively, the GUIs may be displayed on a non-input receiving device such as a conventional liquid crystal display (LCD) monitor, in conjunction with input from separate device such as a keyboard, touchpad or mouse.

The product manufacturers 30 are producers of products, i.e., physical objects. The products may be produced and shipped to consumers in any state of assembly, e.g., fully assembled or partially assembled. In partial assembly, certain individual parts of the product may be pre-assembled by the manufacturer and shipped together for final assembly by the consumer. Each product manufacturer 30 may include one or more computers in communication with the host 20 and, in some instances, in communication with one or more content providers 40. As will be explained, the host 20 may communicate changes to a product manufacturing process to the manufacturer based on computer analysis of user interactions with assembly presentations.

Each content provider 40 may include one or more computers that transmit product information to the host 20. The product information may include various items of information for generating an instructional video concerning a product produced by one of the manufacturers 30. In some instances, the content provider 40 and the manufacturer 30 may be the same entity. However, for purposes of explaining the different roles that each may fulfill, the content provider 40 and manufacturer 30 are discussed separately. The content provider 40 may generate technical schematics of a product, e.g., in the form of a computer aided design (CAD) file. The product information provided by the content provider 40 may include assembly instructions, in particular, an ordered sequence of steps by which an assembly or repair may be completed. The content provider 40 may also specify assembly rules including, for example, consequences of combining the wrong parts together, combining the right parts in the wrong order, or applying the wrong virtual tool to a part.

The host 20 may include one or more computers, such as a central server, that implement the various software engines shown in FIG. 1. However, the functionality of these engines may be implemented equally as well in hardware or a hardware-software combination. The engines include a content search engine 28, an analytics engine 30, a job search engine 32, and a promotions engine 34. The host 20 may further include one or more databases including a content database 22, a user database 24 and a job database 26. The databases and the engines may be implemented locally. Alternatively, one or more databases or engines may be remotely accessed through a network such as the Internet. For example, the content database 22 might be cloud based, e.g., an SAP HANA database. For security, one or more databases may be encrypted.

The content database 22 may store instructional videos or information from which instructional videos are generated for display on a user device 10. In one embodiment, the videos may be stored in advance as 3D animations and transmitted for display on a display screen of the user device 10. In another embodiment, the instructional videos may be generated on demand, e.g., generated at the host 20 for real time transmission to the user device 10 or generated at the user device 10 based on information from the host 20. The content database 22 may also store information for generating the interactive portions of each presentation, e.g., the instructions and rules supplied by the content providers 40. This information may be stored in object files, e.g., a separate object file for each product.

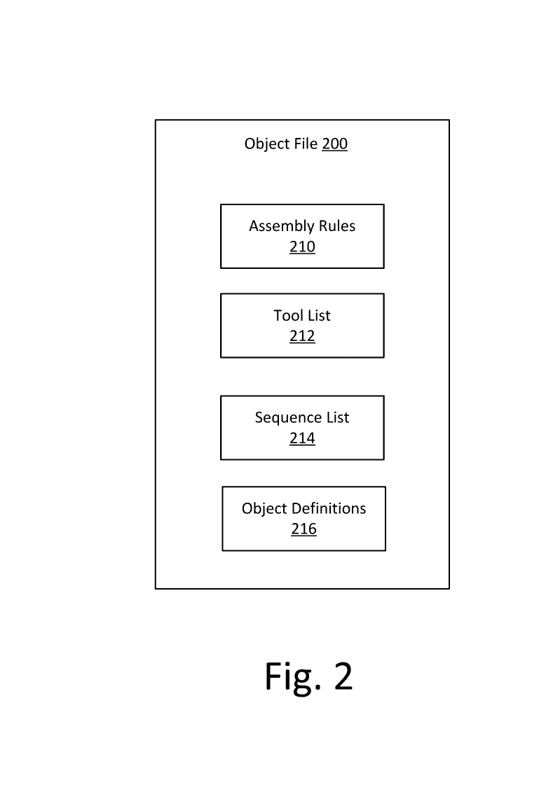

FIG. 2 is an example embodiment of an object file 200, which includes assembly or repair rules 210, a tool list 212, a sequence list 214, and object definitions 216. As mentioned earlier, the assembly rules may specify consequences of combining the wrong parts together, combining the right parts in the wrong order, or applying the wrong virtual tool to a part. For example, a first rule might specify that an alert (audio, visual, haptic, etc.) be output at the user device 10 if the wrong part is combined. A second rule might specify a different alert if the right parts are combined, but in the wrong manner, e.g., placing part A in the wrong location with respect to part B. A third rule might specify that an error message identifying an incorrect action be output. A fourth rule might specify that a certain amount of points be deducted from a calculated performance metric, e.g., a user score (scoring will be explained later) if a threshold condition is met, e.g., a threshold number of incorrect attempts to perform a certain step or a threshold total number of incorrect steps.

The tool list 212 may include a list of virtual tools with real world counterparts used for assembly or repair. Examples include screwdrivers, wrenches, scissors, hammers, glue. Each tool list 212 can define a minimum number of tools needed for completing the assembly/repair.

The sequence list 214 may include an ordered sequence of steps for a particular assembly/repair. Each step may include an associated set of tools and/or parts, in addition to an action which must be performed, e.g., insert part A into a specific location in part B, rotate part C clockwise until X happens, etc. The sequence listing 214 may include a mapping between a step and a corresponding model view of the parts. For example, a lookup table may specify a 3D view of a part from a certain angle. Steps may be mapped to multiple views, e.g., a 3D view plus a two-dimensional (2D) cross-sectional view.

The object definitions 216 may include technical schematics, physics model information (e.g., describing how a particular part rotates or moves), a list of individual parts and descriptions of their functions, etc.

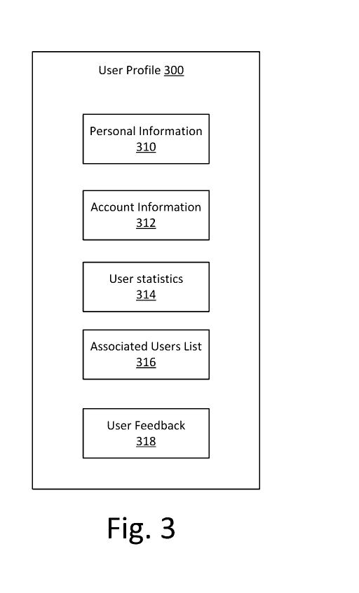

Returning to FIG. 1, the user database 24 may store user profiles and other information regarding the users. FIG. 3 shows an example embodiment of a user profile 300, which includes personal information 310, account information 312, user statistics 314, an associated users list 316, and user feedback 318.

The personal information 310 may include information describing a user, e.g., name, date of birth, location (e.g., a street address, a zip code, a city, a state, etc.), age, gender, etc.

The account information 312 may include a user identifier and a password, or other information by which the user is registered with the host 20. The account information 312 may also include user created content such as recordings of virtual assembly attempts, which may deviate from corresponding instructional videos with respect to sequence of steps, manner of combining parts, parts used or omitted, etc. In one embodiment, the interactive presentation allows the user to create and record an assembly sequence from scratch, e.g., by providing access to a library of parts and virtual tools. Thus, the user may potentially create a new product or modify an existing product so that it differs from its real world or modeled counterpart. This is useful for, amongst other things, exploring “what if” scenarios to show, in a visual manner, the consequences of alternative assembly/repair actions.

The user statistics 314, may include user history information such as data regarding what videos the user has watched, whether and to what extent the user has attempted to interact with the presentations (e.g., the outcomes of previous virtual assembly attempts by the user, what parts or steps the user had difficulty with, what parts the user spent a significant amount of time viewing or manipulating, what steps the user spent the least amount of time trying to perform, etc.). Previous virtual assembly attempts may be scored based on one or more metrics such as total time spent, number of incorrect steps, etc. In one embodiment, assembly/repair tasks are categorized by difficulty level, with higher scores being calculated for more difficult tasks. Scoring may also take into consideration whether the user relied on hints, with points being deducted for hint use. The statistics 314 may include these scores. As explained later, the host 20 may aggregate and analyze statistical and other information (e.g., user feedback), to effect changes in virtual assembly instructions or in manufacturing processes (e.g., how a particular part is designed or what parts are shipped preassembled).

The users list 316 may include a list of other users that the user to whom the profile 300 belongs is associated with. The list may comprise a contacts list of other users (e.g., business acquaintances, product information experts, industry professionals, technicians or repairpersons, co-workers, personal acquaintances, etc.) who transmit messages and user created content (e.g., recordings) to each other, e.g., through a community forum, a social network page or a messaging system, provided by the host 20.

The user feedback 318 may include user created comments regarding an instructional video and/or the corresponding interactive presentation. The comments may be stored in association with the corresponding content in the content database or with user created content, e.g., storing the comments with a link to a user's recording to which the comments are relevant. In some instances, feedback may be solicited by product manufacturers. For example, a manufacturer may be interested in assessing the ability of a particular customer demographic to assemble a product according to its instructional video. The host 20 may search for a user matching the desired demographic and contact the user on behalf of the manufacturer to offer, for example, a coupon in exchange for submitting feedback regarding the instructional video (see discussion below on promotions). Feedback may be based on the user's experience with the interactive presentation. For example, the user may, through attempting to virtually assemble the product according to the video, determine that a step may be skipped or performed differently. Feedback may also be based on real world experience. For example, the manufacturer may ship a product sample to the user and ask the user to attempt real world assembly according to the instructions in the video and note any differences in how the user actually assembled the product.

Returning to FIG. 1, the jobs database 26 may include listings of jobs to which the users may apply. The listings may be created by, for example, product manufacturers and other users. The listings may specify certain prerequisites that must be met before a user may apply for the job through the system 100. For example, listings may specify certain skill sets, certifications, a threshold amount of experience with virtually assembling a product (e.g., a minimum number of successful attempts within a specified time period or a minimum best score).

The content search engine 28 may locate interactive presentations for display at a user device 10 based on user specified search criteria such as product name, product serial number, part number, etc. The content search engine 28 may search relevant data sources, such as the content database 22, for matching presentations and output the results for display at the user device 10.

The analytics engine 30 may perform analysis of user statistics to determine how to improve an assembly or manufacturing process. For example, if a threshold number of users are having difficulty performing a particular step (e.g., as determined based on recorded history or user feedback), the analytics engine 30 may automatically reconfigure the corresponding interactive presentation by, for example, omitting the step from the video and/or a predefined assembly process. In this same example, the analytics engine 30 may also communicate with a product manufacturer's system to instruct or recommend that a corresponding change be made with respect to how the product is manufactured or packaged for shipping. For example, the analytics engine 30 may determine that users are having difficulty combining two parts together, and therefore may recommend that the two parts be shipped preassembled. Conversely, if analytics engine 30 determines that two parts are easy to assemble (e.g., a threshold percentage of users complete a step of combining the parts within a certain amount of time), then the analytics engine 30 may recommend, as a cost saving measure, that the parts be further broken down into sub-parts for shipping. Similarly, the analytics engine 30 may recommend changes in the design of the actual product, e.g., moving a location where one part fits into another or changing a fastening mechanism, in order to improve ease of user assembly, cost of manufacture, or cost of shipping.

The analytics engine 30 may perform consumer behavior analysis based on user profile information to identify opportunities for marketing specific products or services to individual users or user groups. For example, if users who virtually assemble a certain product are clustered around certain geographic locations, the analytics engine 30 may identify those locations as areas in which the same or a related product should be advertised. As another example, the analytics engine 30 may determine that users who assemble Product A tend to assemble Product B. Based on this information, the analytics engine 30 may alert a user who has assembled Product A (but not Product B) to the presence of a promotion concerning Product B.

The job search engine 32 may locate job listings, e.g., in the job database or an external database, that match user specified search criteria. For example, a user with experience in virtual assembly of a particular product may decide to apply for jobs that involve real world assembly of the same product. Additionally, the job search engine 32 may make job recommendations based on user profile information, e.g., what skills or certifications the user has, which products the user has scored well on, what jobs are available within a local area where the user lives, etc. The user may advertise his or her availability for performing a job by publishing contact or scheduling information (e.g., telephone number, email address, days available for work, etc.).

The job search engine 32 may be used to connect the user with other users who are qualified to perform a job for which the user desires assistance. For example, a user whose skills are limited to virtual and/or real world assembly of furniture may be seeking someone to perform a real world repair on a leaky faucet. In this instance, the job search engine 32 may display a list of nearby users with plumbing expertise, together with their contact information and availability. The search engine 32 may rank users based on their user profile. Ranking may be based on a composite score calculated using factors such as the user's scores on relevant assembly/repair attempts, certifications earned, reviews from other users, etc. Composite scores may be calculated for different job categories. For example, if the user has virtual experience repairing faucets in addition to virtual experience repairing toilets, a composite score may be generated for a “plumbing” category based on the user's history in performing both types of repair. Alternatively, a composite score may be generated for each individual product.

The promotions engine 34 may output advertisements or offers regarding the products being assembled or related products and services. For example, the business partner 50 might be interested in selling an accessory to a product that is the subject of an interactive presentation. Promotions may be output to the user in various ways. In one embodiment, an advertisement is displayed in the presentation itself, e.g., in a banner or a popup message. In another embodiment, the software application on the user device 10 may periodically alert the user to the presence of a new offer. Promotions may be sent by email, text message, etc. Promotions may be generated locally at the host 20, or remotely, e.g., at a customer relationship management system. Other forms of promotion besides advertisements include coupons for discounts on products or services. Coupons or virtual currency may be earned in various ways including, for example, participation in a contest where users compete for the highest score in assembling a particular product or series of products (e.g., a contest with several rounds, where the highest scoring users advance to the next round), participation in electronic surveys, submitting user feedback, sharing a recording of product's assembly with a certain number of users, or achieving a threshold number of successful assembly attempts or a threshold score.

Example embodiments of GUIs for implementing the functionality of the system 100 will now be described. The GUIs may be displayed based on processing performed at the user device 10 (e.g., a native mobile application) and/or remote processing (e.g., a web application executed at the host 20).

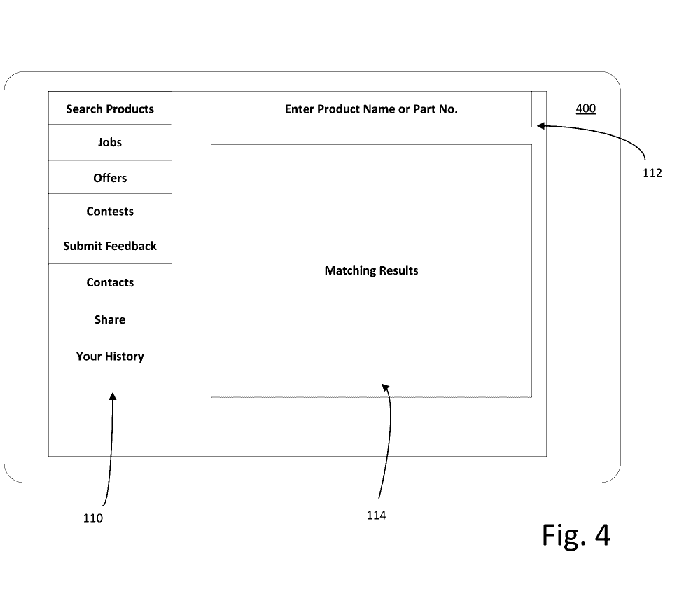

FIG. 4 shows a GUI 400 for locating interactive presentations according to an example embodiment of the present invention. The GUI 400 includes a navigation menu 110, a search field 112, and a results window 114. The menu 110 includes an option to search for products that have interactive presentations. The product search may be performed based on input supplied through the search field 112, e.g., a product name or identifier (barcode, serial number, etc.) or a part number or identifier. Matching results may be displayed in the results window 114.

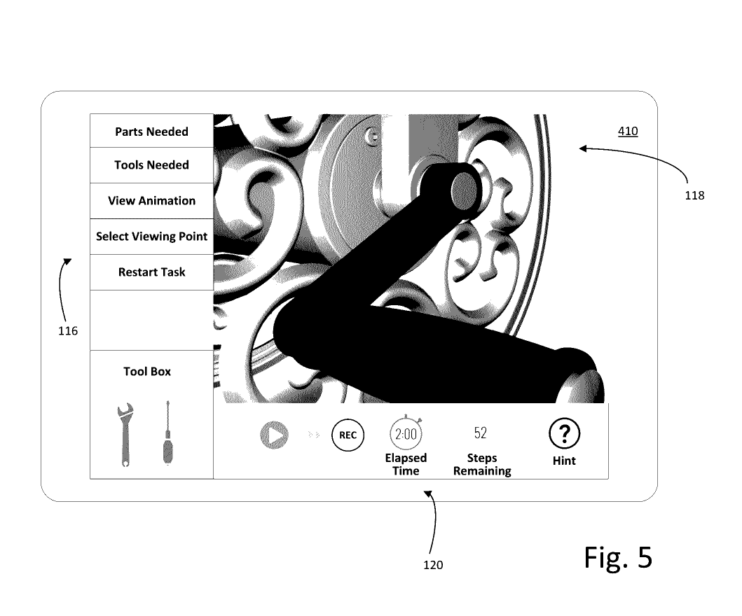

FIG. 5 shows a GUI 410 for presenting an interactive presentation according to an example embodiment of the present invention. The GUI 410 includes a navigation menu 116, a display window 118, and a control panel 120. The menu 116 includes options for displaying, e.g., in the window 118, a list of parts needed for an assembly or repair, a list of tools needed, a 3D animation comprising an instructional video, and starting or restarting a virtual assembly/repair task. A virtual tool box showing which tools are required for performing the task is shown below the menu 116. The video may be displayed in the window 118 and controlled using the control panel 120 and/or menu 116. For example, the GUI 410 may include options to pause or restart the video, to skip to a specific portion of the video, etc.

In addition to viewing the video, the GUI 410 may enable the user to test his or her skills by repeating the actions shown in the video. Thus, the control panel 120 may include a clock showing how much time has elapsed since the user began a virtual assembly/repair attempt, and an indication of overall progress, e.g., how many steps are remaining. The control panel 120 may also include an option for recording the user's actions, e.g., an attempt to follow the video instructions or an attempt to build a new product out of library parts. The control panel 120 may include a hint option by which an audio, visual or other sensory output is produced to help the user advance to the next step. Examples of hints include displaying a message suggesting trying a different part, a message advising on combining two parts in a different way than previously attempted, graphically highlighting an incorrect part, and use of audio or haptic feedback to guide the user towards a correct location on a part.

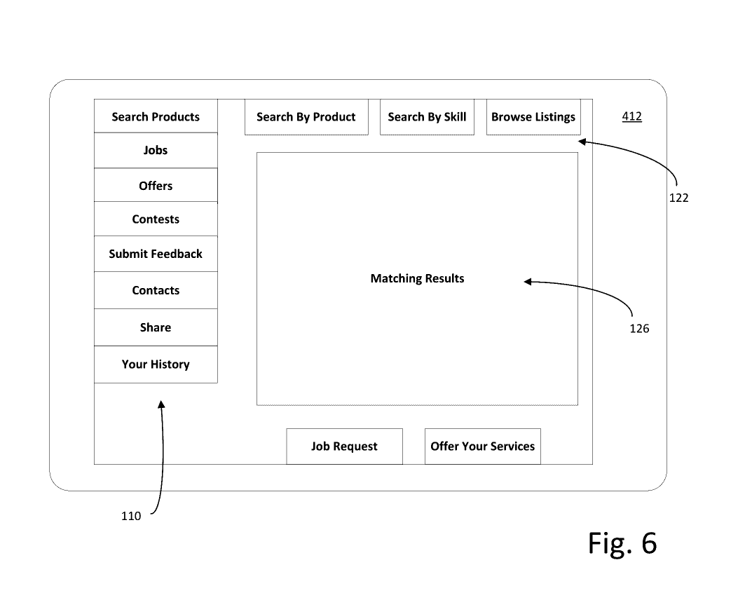

FIG. 6 shows a GUI 412 for accessing a job database according to an example embodiment of the present invention. The GUI 412 may include search and browsing options 122, which enable searching the job database 26 for matching jobs based on product or user skill, or manual browsing through available job listings. Matching job results may be displayed in a window 126. Options may be included for initiating a job request, e.g., to create a help wanted advertisement for a service that the user needs help with, and for offering the user's services, e.g., by posting an advertisement indicating the user's skills and availability.

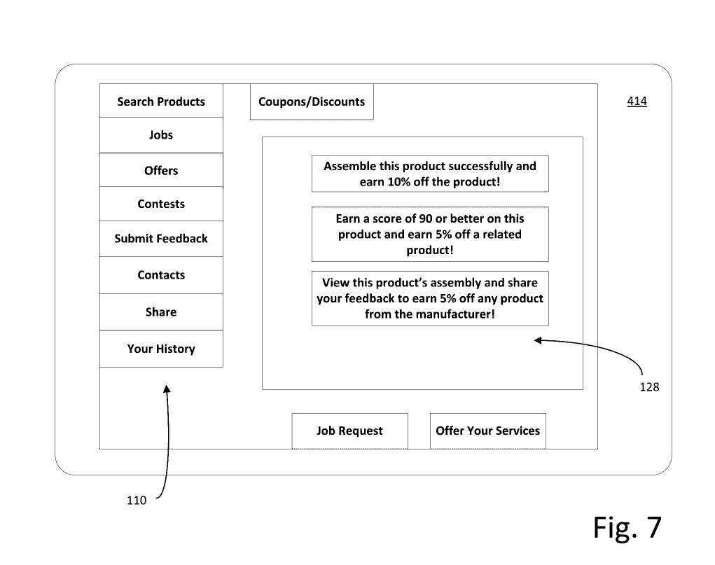

FIG. 7 shows a GUI 414 for accessing presentation related promotions according to an example embodiment of the present invention. As discussed earlier, promotions may include discounts, e.g., coupons, offered in exchange for actions such as completing virtual assembly of a particular product and providing feedback on assembly/repair instructions. The promotions maybe displayed in a window 128.

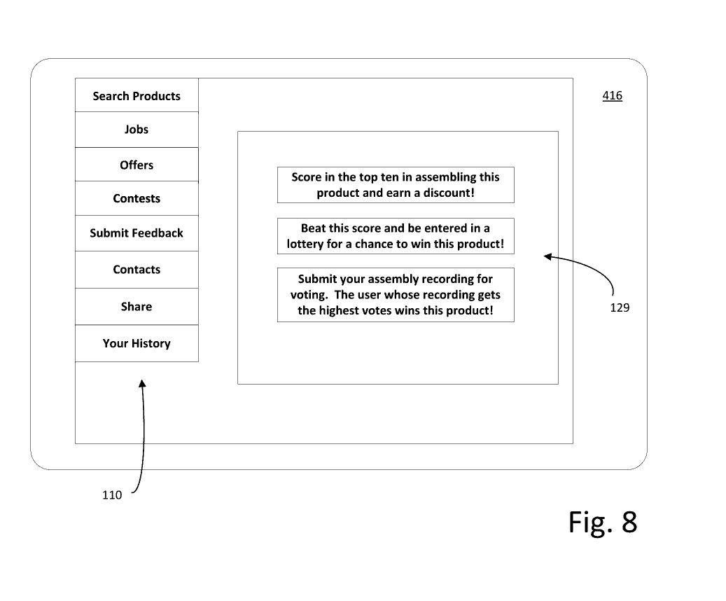

FIG. 8 shows another GUI 416 for accessing presentation related promotions according to an example embodiment of the present invention. The GUI 416 may display, in a window 129, promotions that are competitive in nature, e.g., discounts and other rewards (e.g., a job interview, a networking opportunity, etc.) for earning a high score on a virtual assembly task, getting the most user votes for a shared recording, or achieving a threshold rating level from other users. For example, users may rate each other based on answers to assembly or repair related questions (e.g., posted in an online community forum managed by the host 20) or based on actual assembly/repair performed when hired for a job. The user may compete against himself (e.g., achieving a personal best score), against contacts, or against unknown users (e.g., in periodic contests that are organized by the host 20 and open to any user or to users who meet certain requirements based on their user profile).

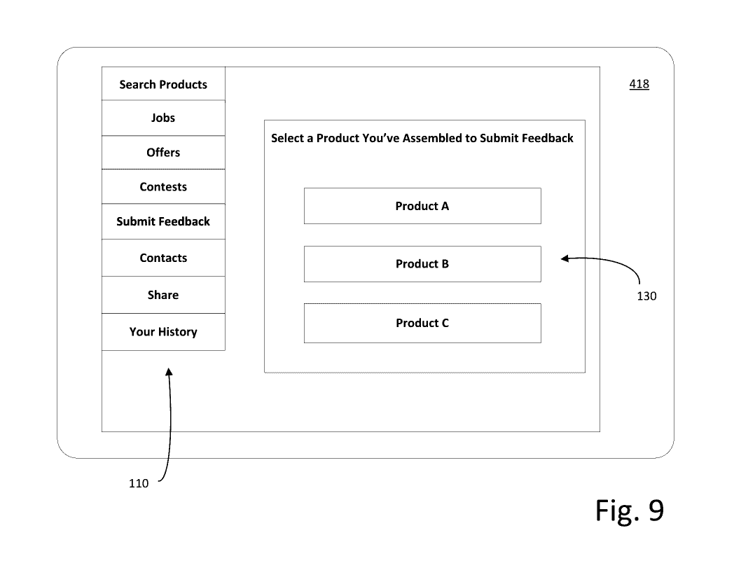

FIG. 9 shows a GUI 418 for submitting presentation related feedback according to an example embodiment of the present invention. Options for submitting user feedback may be presented in a browsable list of products that the user has assembled or repaired, displayed in a window 130. Selecting a product in the list may result in display of further options for submitting feedback regarding the selected product.

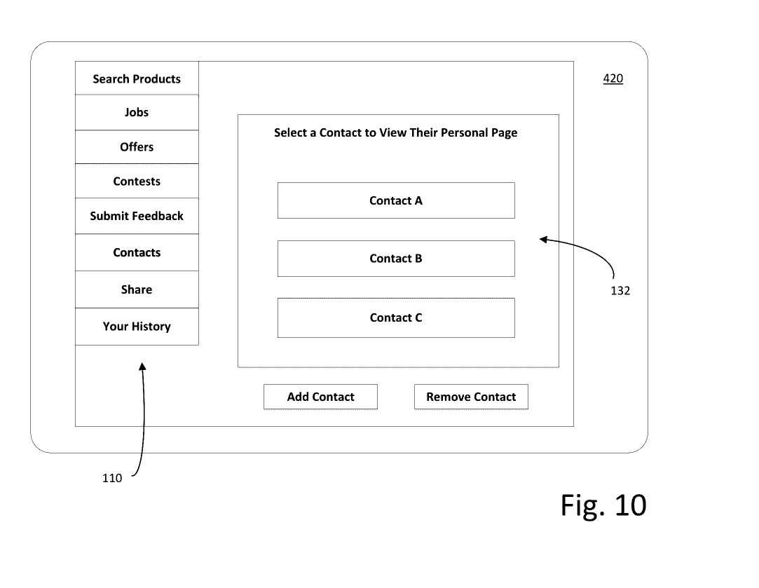

FIG. 10 shows a GUI 420 for accessing profiles of other users according to an example embodiment of the present invention. The other users may be contacts whose profiles are linked to the user based on a stored association in the user's profile. A window 132 may display a list of contacts. Selecting a contact may result in display of a personal page that displays information about the selected contact, e.g., public profile information, published feedback or comments, and links to recordings that the selected contact has shared with the user. The GUI 420 may include options to add or remove users as contacts.

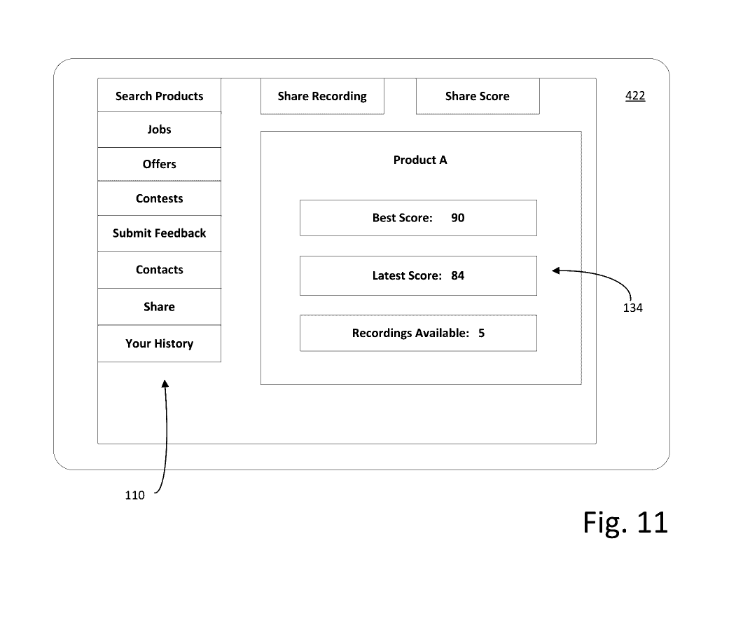

FIG. 11 shows a GUI 430 for sharing interactive assembly results with other users according to an example embodiment of the present invention. A window 134 may display options for sharing user statistics on a particular product, e.g., the user's best score, latest score, or recordings.

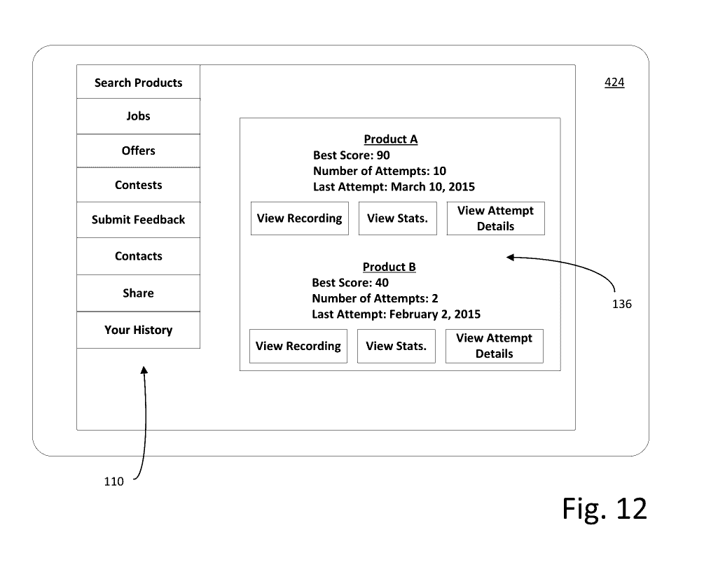

FIG. 12 shows a GUI 424 for accessing assembly results according to an example embodiment of the present invention. The assembly results may comprise a user history of summarized and/or recorded attempts to virtually assemble products. The assembly results may be stored as part of a user profile. A window 136 may display a summary of the user's attempts with different products. Summary information may include, e.g., best score, number of attempts, date of last attempt, etc. Options may be available for viewing recordings, details of individual attempts, and attempt statistics.

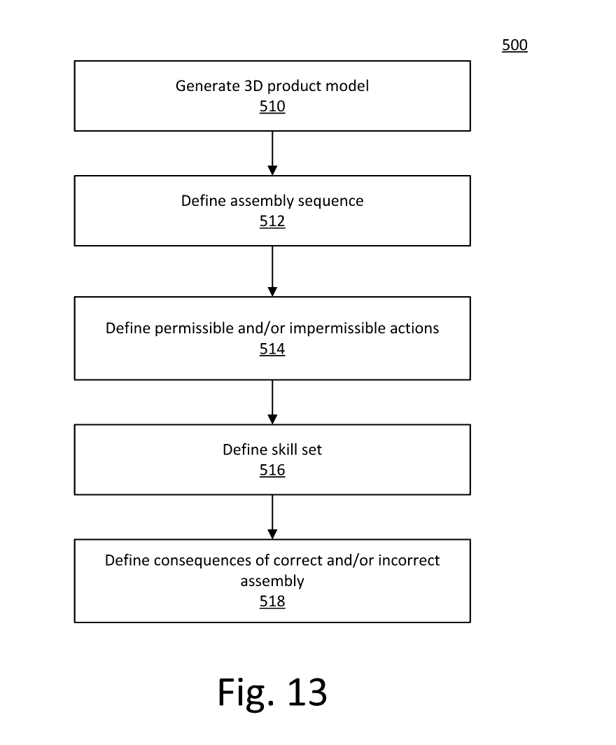

FIG. 13 is a flowchart of a method 500 for creating an interactive presentation according to an example embodiment of the present invention. The method 500 may be performed by a content provider 40 or by the host 20 based on information supplied by the content provider 40. At step 510, a 3D product model is generated, e.g., a CAD file.

At step 512, an assembly sequence is defined, which divides an assembly task into a plurality of steps. The sequence may specify the order in which the steps are performed, together with conditions for successfully completing the steps, e.g., what tools are required, where parts should fit in relation to each other, etc.

At step 514, permissible and/or impermissible actions are defined. For example, merely because a virtual screwdriver may be applied to a particular part does not mean that the interactive presentation should allow the user to do so in the context of assembling a particular product.

At step 516, a skill set may be defined. The skill set may include required or recommended skills for performing the virtual assembly and/or its real world counterpart. Alternatively or additionally, the skill set may include skills that may be developed based on virtual assembly experience. Given sufficient experience, the user may earn certifications and gain recognition for certain skills.

At step 518, consequences of correct and/or incorrect assembly may be defined. For example, as discussed earlier, combining two parts incorrectly may result in a negative impact on score or an error indication.

The information defined in each of the steps 510-518 may be combined into an object file, e.g., the object file 200 of FIG. 2.

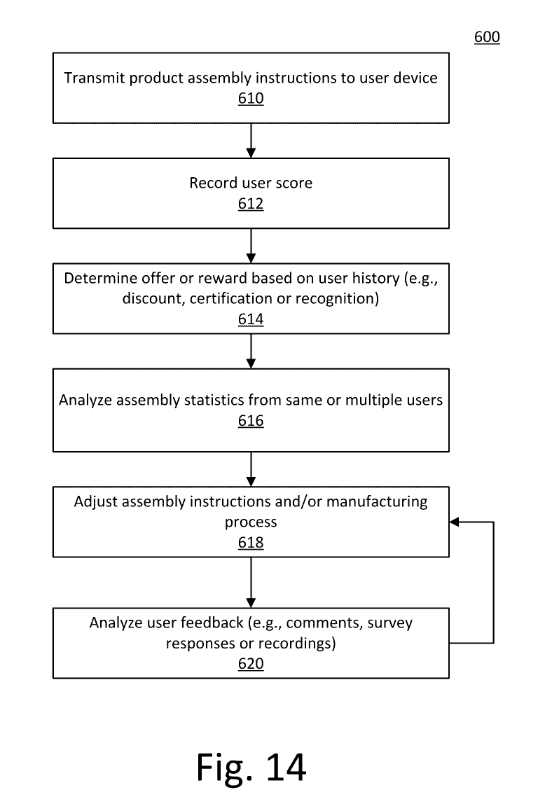

FIG. 14 is a flowchart of a method 600 for analyzing interactive presentation results according to an example embodiment of the present invention. The method 600 may be performed at the host 20. At step 610, product assembly instructions are transmitted to the user device 10, e.g., in the form of an instructional video and/or machine encoded instructions. As mentioned earlier, the instructional videos may be transmitted by the host or generated locally at the user device. Thus, the assembly instructions may include the instructional video or information by which the instructional video is generated at the device (e.g., an object file including a sequence listing).

At step 612, the host 20 records a user score, e.g., a score calculated based on completion time and/or incorrect actions taken. The score itself may be calculated at the user device or the host based on virtual assembly/repair activity detected by the interactive presentation.

At step 614, the host 20 determines an offer or reward based on user history. This may include activity from previous virtual assembly attempts. Alternatively, only the current attempt may be considered for purposes of determining the offer or reward. Examples of offers and rewards were previously described and include, but are not limited to, discounts, certifications (e.g., issued by the product manufacturer or the content provider), and other forms of recognition.

At step 616, the host 20 analyzes assembly statistics from the same user or multiple users (e.g., users who share a common characteristic based on their profile, such as users who assemble the same product). The statistics may be generated at the host 20 or, as mentioned earlier, on a remote computer.

At step 618, the host 20 adjusts assembly instructions (e.g., a real time change in a virtual assembly instructional video) and/or a manufacturing process (e.g., a real time change in how the product is produced or packaged for shipping) based on the analysis results from step 616. In addition to improving assembly instructions, changes to instructions may be performed for purposes of better gauging the user's skill level. For example, a step may be divided into additional steps (e.g., by dividing a preassembled part into smaller parts). Thus, the assembly instructions (and corresponding instructional video) may be dynamically adapted to user skill level and the user's score or reward may reflect a degree of difficulty of the assembly task.

At step 620, the host 20 analyzes user feedback to, amongst other things, implement additional changes to the assembly instructions and/or the manufacturing process in step 618.

As these above described examples show, the present invention takes a unique approach to filling a need. Rather than providing canned answers to the question of how do I (the user) assemble/repair a product, the system can show users how to learn an answer that they'll remember, the answer that is most valuable to them, the answer which best suits their changing needs at any given time. These answers may come from the interactive presentations, from the on-line community of other users and from the user's experience in the off-line community where actual, real world product assembly/repair is performed.

An example embodiment of the present invention is directed to one or more processors, which can be implemented using any conventional processing circuit and device or combination thereof, e.g., a CPU of a Personal Computer (PC) or a mobile computer or other workstation processor, to execute code provided, e.g., on a hardware computer-readable medium including any conventional memory device, to perform any of the methods described herein, alone or in combination. The one or more processors can be embodied in a server or user terminal or combination thereof. The user terminal can be embodied, for example, as a desktop, laptop, hand-held device, Personal Digital Assistant (PDA), television set-top Internet appliance, mobile telephone, smart phone, tablet, etc., or as a combination of one or more thereof. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a non-transitory, hardware computer-readable medium, e.g., as described above, on which are stored instructions executable by a processor to perform any one or more of the methods described herein.

An example embodiment of the present invention is directed to a method, e.g., of a hardware component or machine, of transmitting instructions executable by a processor to perform any one or more of the methods described herein.

The various methods described herein may be practiced, each alone, or in various combinations. Further, steps illustrated in the flowcharts may be omitted and/or certain step sequences may be altered, and, in certain instances multiple illustrated steps may be simultaneously performed.

The above description is intended to be illustrative, and not restrictive. Those skilled in the art can appreciate from the foregoing description that the present invention may be implemented in a variety of forms, and that the various embodiments can be implemented alone or in combination. In additional embodiments, user performance in virtual assembly/repair may be used in an employment setting by incorporating user profile information into an employee record, which may then be used for performance evaluation (e.g., an annual review). User statistics may be used to determine optimal marketing strategies (e.g., how to brand a particular product for a particular market region or user demographic). Access to user statistics may be granted to authorized entities such as manufacturers or business partners, e.g., through a web portal or other communication interface.

Therefore, while the embodiments of the present invention have been described in connection with particular examples thereof, the true scope of the embodiments and/or methods of the present invention should not be so limited since other modifications will become apparent to the skilled practitioner upon a study of the drawings and specification.

What is claimed is:

1. A processor implemented method for generating an interactive presentation, comprising:
outputting a virtual model of a physical object on a display;
receiving data describing actions being applied to the virtual model;
calculating, by a processor, a performance metric based on comparisons between a predefined sequence of physical actions and the applied actions, wherein the predefined sequence describes an assembly or repair process of the object; and
storing the performance metric in a first user profile.

2. The method of claim 1, further comprising:
outputting an instructional video on the display, wherein the video shows the predefined sequence being applied to the virtual model.

3. The method of claim 1, wherein:
the object includes a plurality of parts; and
the predefined sequence includes actions performed on a first object part with respect to a second object part.

4. The method of claim 1, wherein the performance metric is calculated based on at least one of an amount of time required to conform the applied actions to the predefined sequence and a number of applied actions that failed to conform to a corresponding physical action in the predefined sequence.

5. The method of claim 4, further comprising:
determining a conformity of the applied actions based on at least one of an order in which the actions are applied, whether an object part selected for use in an applied action matches a corresponding part in the predefined sequence, and whether object parts are combined according to a predefined physical relationship with one another.

6. The method of claim 1, further comprising:
adjusting the predefined sequence for subsequent performance metric calculations, wherein the adjusting is based on the performance metric.

7. The method of claim 1, further comprising:
adjusting a manufacturing or shipping process of the physical object based on the performance metric.

8. The method of claim 1, further comprising:
recording an applied sequence of actions that deviates from the predefined sequence.

9. The method of claim 8, providing other user profiles with access to the recorded applied sequence.

10. The method of claim 1, further comprising:
awarding a recognition of skill based on the performance metric; and
providing an interface through which a job offered to be performed by a user associated with the first user profile is viewable to other users, wherein the interface displays the awarded recognition to the other users.

11. A system for generating an interactive presentation, comprising:
a content host including a processor configured to:
output a virtual model of a physical object on a display;
receive data describing actions being applied to the virtual model;
calculate a performance metric based on comparisons between a predefined sequence of physical actions and the applied actions, wherein the predefined sequence describes an assembly or repair process of the object; and
store the performance metric in a first user profile.

12. The system of claim 11, wherein the processor is configured to output an instructional video on the display, wherein the video shows the predefined sequence being applied to the virtual model.

13. The system of claim 11, wherein:
the object includes a plurality of parts; and
the predefined sequence includes actions performed on a first object part with respect to a second object part.

14. The system of claim 11, wherein the processor calculates the performance metric based on at least one of an amount of time required to conform the applied actions to the predefined sequence and a number of applied actions that failed to conform to a corresponding physical action in the predefined sequence.

15. The system of claim 14, wherein the processor determines a conformity of the applied actions based on at least one of an order in which the actions are applied, whether an object part selected for use in an applied action matches a corresponding part in the predefined sequence, and whether object parts are combined according to a predefined physical relationship with one another.

16. The system of claim 11, wherein the processor adjusts the predefined sequence for subsequent performance metric calculations, wherein the adjusting is based on the performance metric.

17. The system of claim 11, wherein the processor adjusts a manufacturing or shipping process of the physical object based on the performance metric.

18. The system of claim 11, wherein the processor is configured to record an applied sequence of actions that deviates from the predefined sequence.

19. The system of claim 18, wherein the processor provides other user profiles with access to the recorded applied sequence.

20. The system of claim 11, wherein the processor is configured to:
award a recognition of skill based on the performance metric; and
provide an interface through which a job offered to be performed by a user associated with the first user profile is viewable to other users, wherein the interface displays the awarded recognition to the other users.
